(19) United States
(12) Patent Application Publication
(10) Pub. No.: US 2022/0245449 A1
(43) Pub. Date: Aug. 4, 2022

(54) METHOD FOR TRAINING A SINGLE NON-SYMMETRIC DECODER FOR LEARNING-BASED CODECS

(71) Applicant: SAMSUNG ELETRÔNICA DA AMAZÔNIA LTDA., CAMPINAS (BR)

(72) Inventors: PEDRO GARCIA FREITAS, CAMPINAS (BR); RENAM CASTRO DA SILVA, CAMPINAS (BR); VANESSA TESTONI, CAMPINAS (BR)

(73) Assignee: SAMSUNG ELETRÔNICA DA AMAZÔNIA LTDA., CAMPINAS (BR)

(21) Appl. No.: 17/196,203

(22) Filed: Mar. 9, 2021

(30) Foreign Application Priority Data
Dec. 30, 2020 (BR) 10 2020 027012 5

(51) Int. Cl. G06N 3/08; G06K 9/62; H04N 19/149

(52) U.S. Cl. CPC G06N 3/08; H04N 19/149; G06K 9/6228

(57) ABSTRACT

A method for creating a non-symmetric codec architecture where a single decoder is able to decode the latent representations produced by different neural encoders. Being a single general decoder, the codec generated does not require multiple symmetric decoders, which saves a large amount of disk space. Therefore, beyond reducing the complexity in execution runtime, the embodiments presented herein significantly reduces the space complexity of learning-based codecs and saves huge amounts of disk space, enabling real applications specially in mobile devices.

### CROSS-REFERENCE TO RELATED APPLICATION (s)

This application is based on and claims priority under 35 U.S.C. § 119 to Brazilian Patent Application No. 10 2020 027012 5, filed on Dec. 30, 2020, in the Brazilian Intellectual Property Office, the disclosure of which is incorporated by reference herein in its entirety.

### TECHNICAL FIELD

The present invention relates to a method of compressing images by using codecs based on deep neural networks (DNNs). Codecs based on deep neural networks deliver better visual quality and boosts the performance of coding solutions in electronic devices that employ imaging technologies, such as immersive displays, holographic smartphones, cameras, headsets, AR/VR/MR devices, smart TVs, etc.

Moreover, the method reduces memory consumption by DNN-based decoders. The method creates a non-symmetric codec architecture where a single decoder can decode the latent representations produced by different neural encoders. This architecture presents several benefits such as reduced number of model parameters, reduced memory usage, reduced space to store the model, easy processing pipeline and reduced decode processing complexity.

### BACKGROUND

Some video and image compression standards have been proposed in the last decades. For instance, AVC/H.264 (the most widely used video codec), HEVC/H.265, and the most recent standard from MPEG known as VVC/H.266. All these standards describe hybrid coding architectures based on motion-compensated prediction and transform coding. However, these algorithms rely on hand-crafted techniques to reduce the information redundancies (e.g., motion estimation, integer transform, intra-prediction, etc). These hand-crafted techniques have been developed over many decades and the standardization activities have served to filter the most feasible ones for the industry.

Nevertheless, more recently, DNN-based autoencoders have achieved comparable or even better performance than the traditional image and video codecs like JPEG, JPEG2000 or HEVC. This is because the DNN-based image compression methods make use of an end-to-end training strategy, which enables the creation of highly nonlinear transforms based on data that are more efficient than those used in traditional approaches.

Despite the advantages of DNN-based codecs, a central inconvenience hinders their widely use in practical applications. This inconvenience relates to the decoder disability in decoding inputs (latent representations) encoded at different (multiple or variable) bitrates. Currently, the available DNN-based techniques require specific and symmetric encoders and decoders pairs in order to compress and decompress image or video data at a given bitrate.

Recently, deep neural networks have attracted a lot of attention and have become a popular area of research and development in industry. This interest is driven by many factors, such as advances in processing hardware, the availability of huge data sets and improvements on neural network architectures. Deep neural networks perform better than the state-of-the-art solutions for several tasks, such as image classification, object segmentation, image inpainting, super-resolution, and visual saliency detection. Further to the abovementioned progress, another attractive feature of DNN-based image codecs is the possibility of being extensible to support future image features. Specifically, when new image features (e.g., higher resolutions) are developed, new hand-crafted compression techniques need to be developed to give support in traditional codecs. On the other hand, DNN-based codecs could support the new features by re-training the neural network using images with the new features.

However, DNN-based image codecs have not yet been widely deployed in practical applications. Some reasons include diffidence in metrics, lead-time required to establish and consolidate a standard and hardware requirements. Among the various challenges to be surpassed in defining a robust DNN-based codec, the complexity reduction of neural networks is crucial to enable real-time applications. Another problem to be overcome is the definition of bit allocation and rate control. Currently, the bit allocation is set by state-of-the-art DNN-based codecs at the training stage. More specifically, when a DNN-based codec is trained to achieve a given rate, two sets of learned parameters must be defined: one for the encoder and another to the decoder. Therefore, to achieve different trade-offs between quality and bitrate, current DNN-based codecs must employ multiple encoder-decoder pairs, where each pair is learned with its own parameters. Although effective in terms of rate-distortion, this symmetric approach leads to high memory and computation usage, what may refrain the development and deployment of practical DNN-based codecs, especially in mobile devices.

Patent document US20200027247A1, entitled “Data compression using conditional entropy models”, published on Jan. 3, 2020, by GOOGLE LLC., describes a method and system to compress images using the latent representation obtained from a neural network. This latent representation is compressed using an entropy encoder whose entropy model is modelled using a hyper encoder. The present invention, on the other hand, describes a method to train a single learning-based decoder that can decompress bitstreams at different bitrates. Using the method described in US20200027247A1, several encoders and decoders must be trained in order to compress and decompress bitstreams at different rates. The proposed invention enables the use of a single decoder to decompress these different bitstreams.

Patent document US20200111238A1, entitled “Tiled image compression using neural networks”, published on Apr. 9, 2020, by GOGGLE LLC., describes a method for learning-based image compression and reconstruction by partitioning the input image into a plurality of tiles and then generating the encoded representation of the input image. The method processes a context for each tile using a spatial context prediction neural network that has been trained to process context for an input tile and generate an output tile that is a prediction of the input tile. Moreover, the method determines a residual image between the tile and the output tile generated by the spatial context prediction neural network and generates a set of binary codes for the particular tile by encoding the residual image using an encoder neural network. However, the proposed invention describes a method to train a single learning-based decoder that can decompress bitstreams generated using a diverse bitrate.

The article “Scale-Space Flow for End-to-End Optimized Video Compression”, published on Jun. 13, 2020 by Agustsson et al., shows that a generalized warping operator that better handles common failure cases (e.g. fast motion) can provide competitive compression results with a greatly simplified model and training procedure. Specifically, the paper proposes scale-space flow, an intuitive generalization of optical flow that adds a scale parameter to allow the network to better model uncertainty. The paper regards a low-latency video compression model (with no B-frames) using scale-space flow for motion compensation. Our invention is a method to train a general decoder for learning-based image and video codecs. While Agustsson's method requires the video decoder to be jointly trained with a specific video encoder to be able to decompress a bitstream compressed at a specific bitrate, our invention enables the creation of a general decoder that can decompress bitstreams encoded at multiple bitrates.

The article “Computationally Efficient Neural Image Compression”, published on Dec. 18, 2019, by Johnston et al., describes an investigation over automatic network optimization techniques to reduce the computational complexity of a popular architecture used in learning-based image compression. Specifically, the paper analyzes the decoder complexity in execution runtime and explores the trade-offs between two distortion metrics, rate-distortion performance and run-time performance to design and research more computationally efficient neural image compression. Our invention, on the other hand, proposes a method for training learning-based codecs to create a general decoder that can decode bitstreams encoded at multiple bitrates. Being a single general decoder, the codec generated using our invention does not require multiple symmetric decoders, which saves a large amount of disk space. Therefore, in addition to reduce the complexity in execution runtime, this invention significantly reduces the space complexity of learning-based codecs and saves huge amounts of disk space, enabling real applications specially in mobile devices.

### SUMMARY

The present invention discloses a method for creating a non-symmetric codec architecture where a single decoder is able to decode the latent representations produced by different neural encoders. Being a single general decoder, the codec generated using our invention does not require multiple symmetric decoders, which saves a large amount of disk space. Therefore, beyond reducing the complexity in execution runtime, the embodiments presented herein significantly reduces the space complexity of learning-based codecs and saves huge amounts of disk space, enabling real applications specially in mobile devices.

### BRIEF DESCRIPTION OF THE DRAWINGS

The objectives and advantages of the current invention will become clearer through the following detailed description of the example and non-limitative drawings presented at the end of this document:

FIG. 1 presents an example of a multimedia application with support to multiple compression rates.

FIG. 2 presents a scheme with multiple bitrates using the current state-of-the-art learning-based encoder/decoder pairs.

FIG. 3 illustrates the results of a decoded image using symmetric decoders.

FIG. 4 illustrates a graph representing the sizes of trained codecs (in megabytes).

FIG. 5 depicts the Proposed framework to train a single non-symmetric decoder for learning-based codecs.

FIG. 6 depicts a flow diagram example of the decoder training for decoding three distinct bitrates.

FIG. 7 depicts an embodiment of a transmission system for video streaming.

FIG. 8 depicts an embodiment of the present invention being used as part of an image viewer application on a smartphone.

FIG. 9 depicts a comparison between the original image (first column) and the decoded images using specific symmetric decoders (second column), a proposed non-symmetric decoder with 96 convolutional filters (third column), and a proposed non-symmetric decoder with 192 convolutional filters (fourth column).

FIGS. 10(a), 10(b) and 10(c) depict the rate-distortion (R-D) curves using Peak Signal-to-Noise Ratio (PSNR), Video Multi-Method Assessment Fusion (VMAF), and Multi-Scale Structural Similarity Index Measure (MSSIM) metrics.

### DETAILED DESCRIPTION

Multimedia applications often support visual media such as image and video. These applications must compress the images or videos to accomplish efficiently the user's purpose of communicating/consuming visual information. Particularly, applications that transmit media through the Internet usually offer multiple options of compression rates.

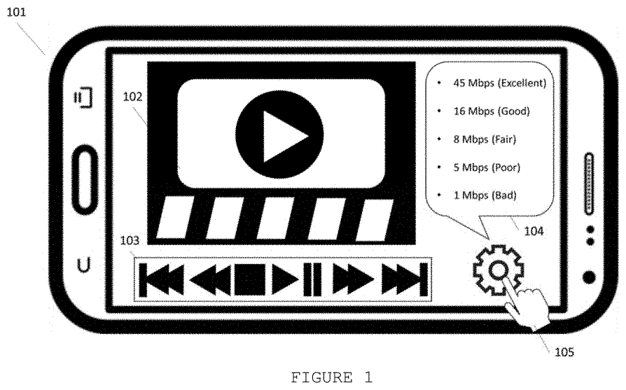

FIG. 1 illustrates a general interface of this kind of application. A mobile device 101 application with a reproduction area 102 that presents a video or image media received through Internet. If the network bandwidth is not enough to support the image or video, the app will freeze the media rendering. This freezing often leads the users to stop the rendering manually using the controller 103 until the media is completely buffered in the device. Nevertheless, if this procedure needs to be repeated, the user experience is significantly impaired. In order to avoid this problem, a common solution is to provide the media with various compression rates 104. Thus, the user can choose the rate that provides the best experience constrained by the available bandwidth 105.

The various compression rates imply in different visual qualities. However, since the users choose the option that best suits them, the challenge for the designer of the application is to define how these multiple rates will be generated. In traditional image and video codecs, the rate control is determined based on a quantization parameter defined by the encoder during compression to define a range of values a single quantum value can have.

Rate control in traditional codecs depends on the quantization and does not depend on any encoder internal state. Additionally, since they are hand-engineered, the coding process follows well-defined steps and every decision made at the encoder is stored in the bitstream, so the decoder is able to reconstruct the visual media from the encoded bitstream. As such, multiple bitrates can be achieved using a single traditional encoder and, subsequently, a single traditional decoder, requiring only a quantization parameter to be passed indicating whether the encoder should preserve more or less of the original information.

Differently from the traditional ones, learning-based codecs must be prepared to achieve a given compression rate. Especially on CNN-based codecs, this preparation is done at the training stage by using a Lagrangian rate-distortion function as loss function. The Lagrangian rate-distortion function depends on a lambda parameter, a distortion measure, and the rate. The optimization algorithm attempts to find parameters for the model that minimizes the loss function over a large training dataset. Thus, both distortion and data rate need to be evaluated in the course of training, depending on the lambda parameter, the Lagrangian multiplier privileges rate or distortion. Therefore, it can be noticed that, in the state of the art, several pairs of encoders and decoders must be trained in order to provide multiple compression rates.

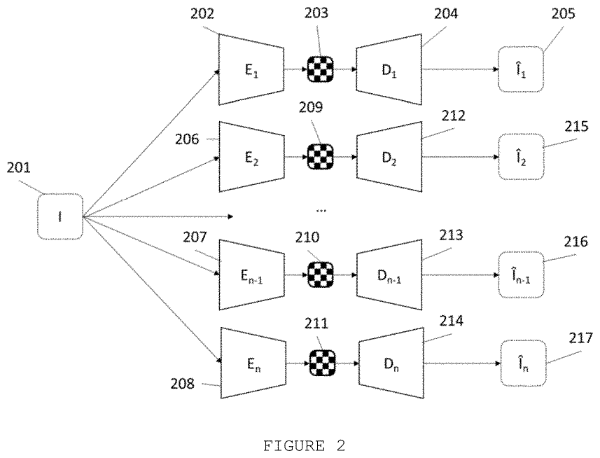

FIG. 2 illustrates how a system based on the current state of the art CNN-based codecs can be implemented to provide multiple compression rates. A pristine media 201 is used as input to an encoder 202 previously trained with a given Lagrangian rate-distortion function to achieve a certain bitrate. This encoder will generate a latent representation 203, which is the compressed representation of the input media. This latent representation is fed to a decoder 204, which is the pair of the encoder 202, to reconstruct the original media 205. Since the pair of encoder 202 and decoder 204 are jointly trained, and assuming that during the training stage the quality was privileged over small bitrates, another similar codecs are used to favor lower bitrates instead of quality. So, supposing that a given application needs n quality levels then it needs n encoders (206, 207, 208). Each of these encoders generates different latent representations (209, 210, 211) with different sizes. Each of these latent representations can only be decoded by a specific decoder (212, 213, 214). Therefore, different quality levels of the decoded media (215, 216, 217) require multiple pairs of symmetric codecs to be produced.

Independently of the latent representation bitrate generated by different encoders, the storage needed to hold the parameters of the trained CNN is quite similar. For instance, when the codec is trained with {0.0001, 0.001, 0.01, 0.1, and 1.0} as lambda values, a range of quality and bitrate is created, as can be noticed from Picture 3.

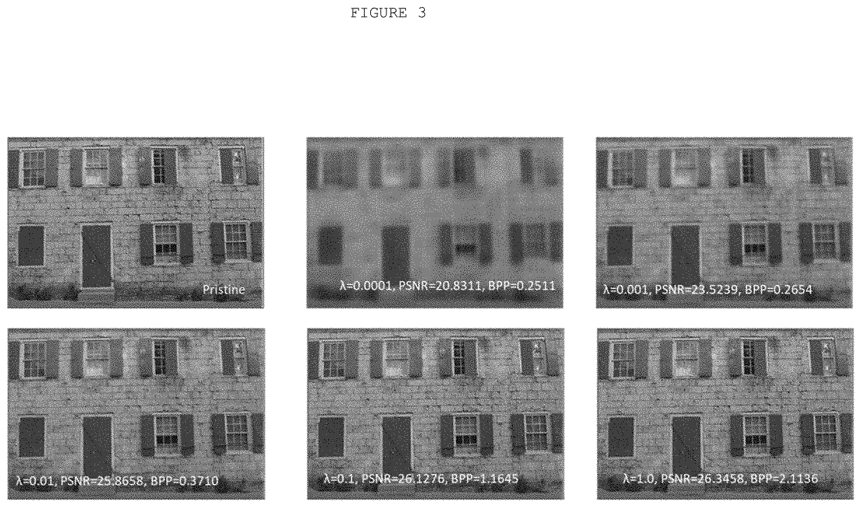

A specific pair of encoder and decoder is used to generate each image in FIG. 2. Despite the diversity of quality and rate presented in FIG. 3, which depicts the results of decoded image using symmetric decoders, the file size of the different codecs is quite similar.

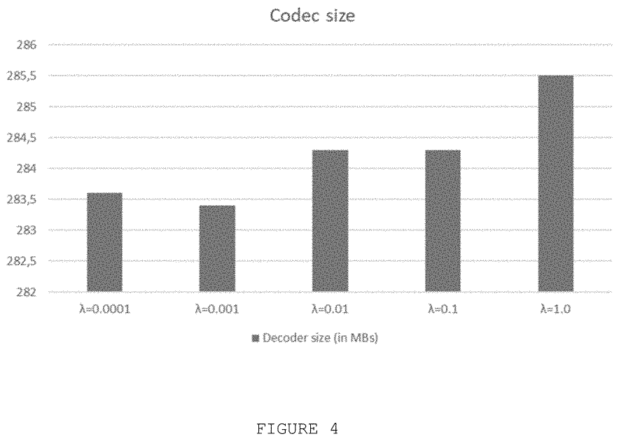

As can be observed from FIG. 4, the corresponding sizes of the CNN weights that form the codecs are 283.4, 283.6, 284.3, 284.3, and 285.5 MBs. The variance between them is about 0.5, which is quite small if the total file size of each codec is considered.

Considering the aforementioned examples, the total disk space required to store all trained codecs is 1421.1 megabytes. The decoders alone take up half of this space, approximately 710 megabytes. For that reason, to provide only 5 compression levels of bitrate, a device must store more than a half of a gigabyte. This is one of the main problems preventing learning-based coders as commercial applications. This problem particularly involves the decoder side because the decoders are much more used than the encoders. In fact, most end-user multimedia applications often implement only the decoder. For instance, almost all streaming services do not encode data, but only play the videos. Similarly, in these applications the already-compressed images are downloaded from the server and then exhibited in the screen.

In both cases, because the downloaded media is already encoded in the server-side, only the decoder is required in the user device. Therefore, the creation of a general decoder that is able to decode bitstreams generated from a diverse range of bitrate and quality level is crucial to make feasible learning-based codecs in real application, especially in mobile devices.

The present invention describes a method to train a general decoder for learning-based image and video codecs. This general decoder is constructed by training a non-symmetric encoder-decoder architecture. This architecture employs a single decoder that can decode latent representations produced by a set of previously trained encoders.

In this sense, it is described a Method for training a single non-symmetric decoder for learning-based codecs, comprising the steps of:

a) receiving the training data;

b) training N symmetric encoder/decoder pairs for N different bitrates;

c) discarding N decoders from the encoder/decoder pairs;

d) fixing the encoder weights;

e) instantiating a non-symmetric decoder;

f) creating the non-symmetric decoder by updating only the decoder weights;

g) determining a general decoder capable of decoding N different bitrates.

This single non-symmetric decoder is constructed using a two-step training. In the first step, a set of symmetric encoder-decoder pairs is created using the state of art approach illustrated in Picture 2. In order to achieve various bitrates and quality levels, different Lagrangian multipliers values are set. These different values are chosen to cover the desired range of rate-distortion trade-offs. After training the symmetric models with the needed configurations, the trained neural network parameters (weights, biases, etc.) are saved to be used in the second step.

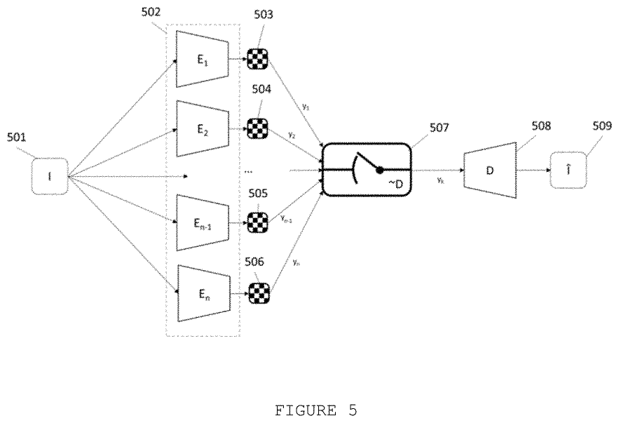

The second step is illustrated in Picture 5 for a single training iteration 501. The procedure illustrated in FIG. 5 is repeated for all media in the training dataset. The set of encoders 502 previously trained in the first step is frozen during the second training step. In this manner, the neural network parameters learned in the first step are not updated in the second step in order to make the decoder able to decode the latent representation produced by any of the previously trained encoders. The input is encoded by all encoders, which generates different latent representations (503, 504, 505, 506). These latent representations have different distortion levels and, as consequence, different bitrates. During training, at certain training step and parameter update, a single latent representation is used to update the decoder. This latent is randomly selected from those produced by the encoders by a random switcher (507). In other words, the same input is encoded by the n encoders available, which generated n latent representations, denoted as {y1, y2, . . . , yn-1, yn} in FIG. 5. For each input in the training procedure, a randomly selected latent representation {yk} is used to update the decoder parameters. After several iterations, the decoder learns how to decode the latent representation generated from different encoders. After trained, the decoder (508) can reconstruct (509) the input independently of the latent representation, regardless of the encoded bitrate, and, therefore, can substitute the n symmetric decoders.

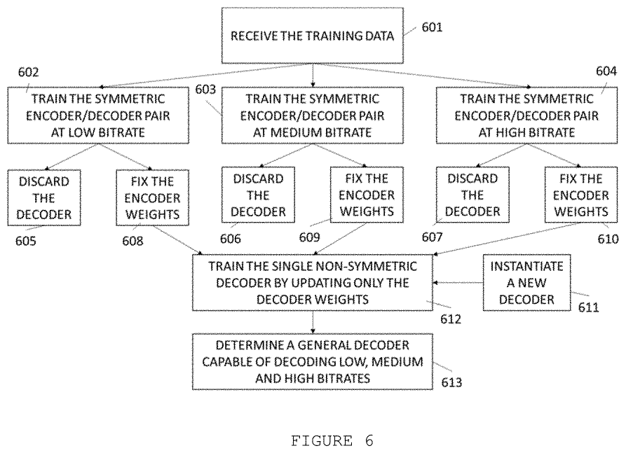

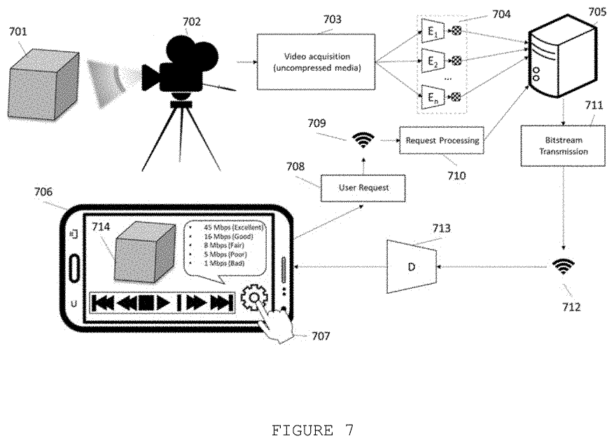

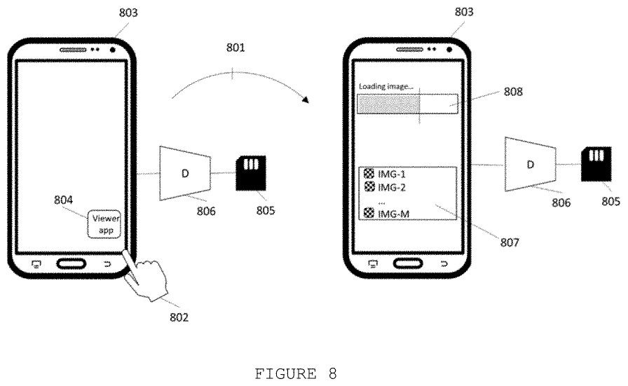

FIG. 6 is a flow diagram of an example process for training the non-symmetric codec. For convenience, the process will be assumed as being performed by a system of one or more computers located in one or more locations. For instance, a system implementation described with reference to Picture 2 and Picture 5, appropriately programmed in accordance with the present application. The system receives a training data (601), which can be any appropriate form of data, e.g., image, or video data. The system processes the data using multiple symmetric encoder-decoders pairs to generate multiple latent representations of data, e.g., at low (602), medium (603), and high (604) bitrates. After trained, the system discards the trained symmetric decoders (605, 606, 607) and makes the trained encoder weights constants (608, 609, 610). These fixed weights are used in a second training stage that performs the steps depicted in Picture 5. The system instantiates a new decoder (611). The system uses the training data as input in the fixed encoders to (605, 606, 607) to update the weights of the new instantiated decoder (612). After trained, the non-symmetric decoder can reconstruct different latent representations (613).

Picture 7 shows an embodiment of the invention used in video streaming system. A video streaming system includes a video being captured, transmitted and then visualized. In Picture 7, a scene from the real world (701) is filmed using a digital camera (702), which captures an uncompressed video (703). A computing device (704) associated with the camera (702) compresses the video (703) using a pre-trained learning-based video encoder at multiple quality levels and, as consequence, different compression rates. The compressed representations are then stored in a network media server (705). In the receiver side, a computing device with an appropriate screen interfaces the application with the user (706). The user (707) can interactively change the quality level and the compression rate in order to achieve the best experience. The requested quality level (708) is transmitted over a network channel (709) to the media server (705). The media server (705) processes this request (710) and transmits it back (711) via network channel (712). A computing device contains the decoder generated using this invention (713) and performs the decompression step to restore the original video data. The decompressed video is then played in the device screen (714).

Picture 8 shows another embodiment of the invention to render images on mobile phones. Picture 8 depicts this embodiment of the present invention on an image visualizer. The solid arrow (801) represents the sequence of events within the embodiment execution. The action starts with a user (802) using a smartphone (803), where a system implementing the proposed invention was previously deployed in the form of an image viewer application (Viewer App) 804. The app stores the compressed images in a memory component (805) (e.g., in the smartphone internal memory, in the cloud, or in another device). The system contains a learning-based image decoder trained according to this invention (806). The user (802) selects the compressed images (807) stored in the device. The chosen image is read from the memory (805) and decoded using the decoder (806) and then shown on the screen (808).

The present invention was tested using as training dataset, a subset from JPEG AI challenge training dataset. It includes 5283 images with resolutions ranging from 1080p to 4K. During training, these images were cropped to 256×256 for processing performance purposes. The inference (i.e., encoding and decoding stages) was tested using Kodim01 image from Kodak dataset.

The training of the symmetric codec was performed with different values for the Lagrangian multiplier, namely 0.00001, 0.0001, 0.001, 0.01, 0.1, and, 1.0. For each of these 5 values, a model with 8000 parameter updates (iterations) was trained. Using these trained encoders, the non-symmetric decoder was trained with one million iterations. In the symmetric architecture, both encoder and decoder are trained with 192 convolution filters. The proposed general decoder was tested using two simulations, one trained with 96 and other with 192 convolution filters.

The first effect to point out is that with the present invention the processing flow for decoding a given image is drastically simplified. For a decoder implementing the usual approach, the decoder is required to partially decode the given bitstream to identify the encoder used to generate the latent representation, load the corresponding decoder's parameters from a storage device, and then produce a decoded image. This processing pipeline would be performed for every image received by the application employing such approach. On the other hand, the single decoder produced with the proposed non-symmetric promptly produces a decoded image, the decoder's parameters would be loaded once reducing the number reading from disk and storage space to hold model parameter and facilitating processing pipeline.

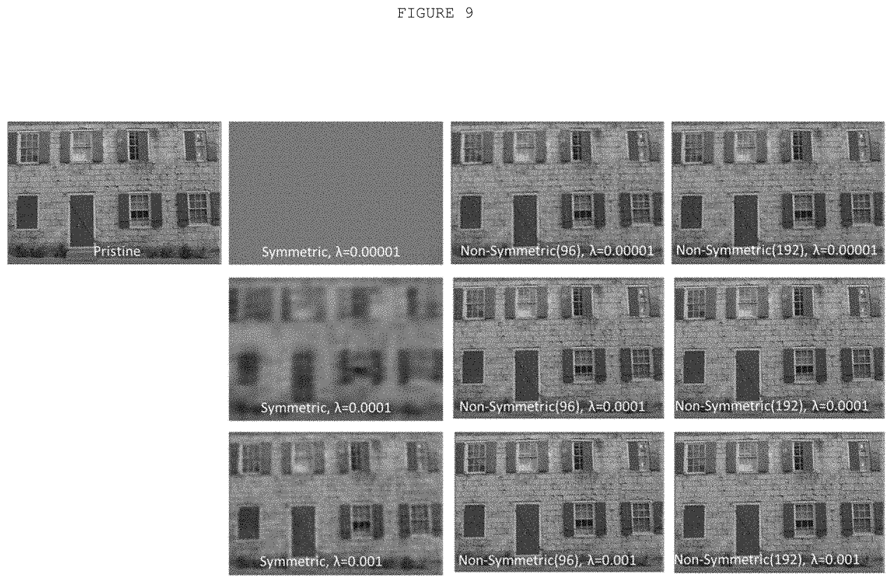

FIG. 9 shows the reference pristine image (top-left) and its decoded versions using each of the symmetric encoder-decoder pairs and the two general decoders trained with 96 and 192 convolutional filters, respectively. This picture shows that the three different Lagrangian multiplier values used in this example (i.e., 0.00001, 0.0001, and 0.001) generate distinct quality levels, as expected. It is worth mentioning that all decoded images in the same line were reconstructed from the same latent (compressed) representation. In the case of symmetric codecs (second column), a decoder is assigned to a specific encoder linked to lambda. On the other hand, the results from non-symmetric codecs (third and fourth columns) were obtained using the same decoder, independently of the lambda.

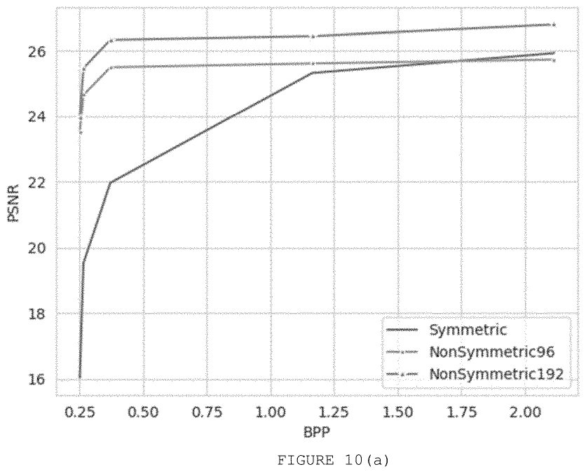

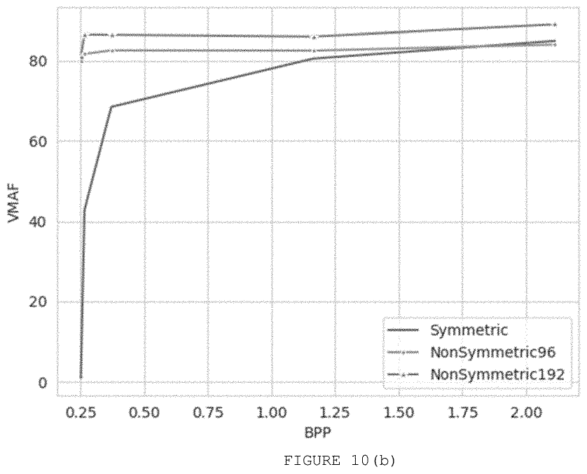

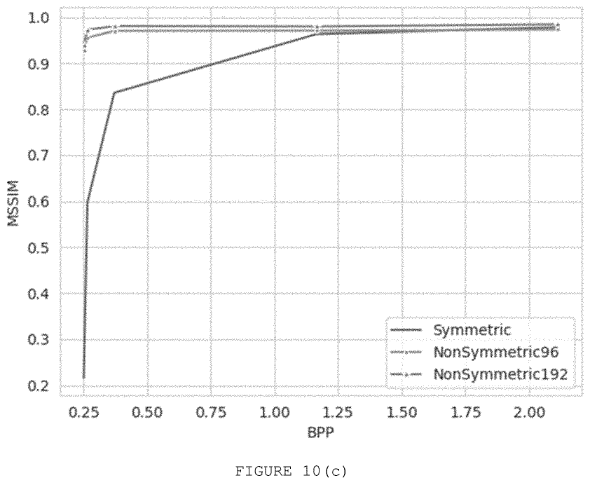

FIGS. 10(a), 10(b) and 10(c) results in terms of R-D (Rate-Distortion) performance. For the same point in the x-axis, the higher the point in the y-axis, the better. In other words, the lower curves indicate worse performance while the superior curves indicate better results. Based on these figures, it is possible to have an overall idea of the performance of the testing codecs. When analyzing the R-D curves, it can be noticed that the results produced by the decoders from the non-symmetric architecture, which were trained using the present invention, present better R-D performance when compared with the symmetric ones, especially for the lower bitrates.

Although the R-D curves provide a general performance overview of the tested codecs, specific R-D points are better compared using the Bjøntegaard Delta. Bjøntegaard Delta is a metric that enables the comparison of R-D curves in terms of the average quality improvement or the average bitrate saving. This metric takes a curve as reference and, based on the reference, it can measure how much the bitrate is reduced or increased for the same Peak Signal-to-Noise Ratio (PSNR). Taking the symmetric decoders as reference, it can be noted that the non-symmetric decoder generated using the proposed invention presented a significant and consistent rate reduction when compared with the symmetric codec. Specifically, using a decoder with 96 convolutional filters, the bitrate reduction was about 56.31%. The decoder trained using the same convolutional neural network but with 192 convolutional filters achieved a bitrate reduction of 72.95%. Therefore, it is possible to notice that the greater the number of convolutional filters, the better the quality of the decoded latent.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although the present invention has been described in connection with certain preferred embodiments, it should be understood that it is not intended to limit the disclosure to those particular embodiments. Rather, it is intended to cover all alternatives, modifications and equivalents possible within the spirit and scope of the disclosure as defined by the appended claims.

What is claimed is:

1. A method of training a single non-symmetric decoder for learning-based codecs, comprising:
receiving training data;
training N symmetric encoder/decoder pairs for N different bitrates;
discarding N decoders from the encoder/decoder pairs;
fixing encoder weights;
instantiating a non-symmetric decoder;
training the non-symmetric decoder by updating only decoder weights;
determining a general decoder capable of decoding N different bitrates.

2. The method as in claim 1, wherein N different Lagrangian multipliers values are set in the training.

3. The method as in claim 2, wherein symmetric models are trained, and trained neural network parameters are stored.

4. The method as in claim 1, wherein trained neural network parameters are selected from a group including weight and biases.

5. The method as in claim 1, wherein encoding the training data generates N different latent representations (y₁, y₂, yₙ₋₁, yₙ).

6. The method as in claim 1, wherein, for each input in the training of the non-symmetric decoder, a latent representation {yₖ} is randomly selected by a random switcher to update decoder parameters.

7. The method as in claim 1, wherein the N symmetric encoder-decoders pairs are used to generate multiple latent representations of data are at low, medium, and high bitrates.
